(19) United States
(12) Patent Application Publication
(10) Pub. No.: US 2012/0260465 A1
(43) Pub. Date: Oct. 18, 2012

(54) Wireless headset pincher holding device that suspends or secures a wireless headset to a user by clipping it to the shirt collar, shirt pocket or article of clothing in a way that will prevent damage, theft, annoyance, and loss of the wireless headset

(76) Inventor: Christopher Glynn R. Hunter, Woodstock, GA (US)

(21) Appl. No.: 13/086,943

(22) Filed: Apr. 14, 2011

(51) Int. Cl. H01F 7/02; F16B 2/20

(52) U.S. Cl. 24/3.12; 24/303

(57) ABSTRACT

This apparatus is for suspending, keeping track of and holding a wireless headset near the head of the user for easier use and prevention of loss of any wireless headset, ear bud, Blue-Tooth wireless headset, earphone used with any cellular phones, mobile phones, portable phones, desk phones, wireless hand-helds, wireless PDA's or other wireless device also including a phone and headset merged together in the future. I will refer to these as “wireless headsets.” This apparatus is attached to an article of clothing, or other area, by means of a small, lightweight clip. In our preferred embodiment, the clip or pinching mechanism is connected to a magnet, magnetized material or other magnetic item (hereby referred to as a “magnet”) by way of glue or manufacturing process, that attracts or holds onto a small piece of metal adhered to the wireless headset. The small piece of metal or ferromagnetic material can be shaped to fit the landscape of any headset. The small piece of metal adheres to the headset by way of adhesive affixed to one side of the metal and has a peel-off backing. The backing removed, exposes the adhesive and is pressed onto the headset. The magnet on the clip attracts and holds the metal piece and headset in place. The user can “dock” the headset with the magnet on the clip. The wireless headset is connected to the user, easily applied to the ear and safe from damage or loss.

### FIELD OF INVENTION

The field of invention is mainly telecommunications accessories used in conjunction with mobile phones, cellular phones, smart phones, hand-helds, PDA's and other hand-held computers, communications or media devices and wireless headsets or other small accessories that are used with them.

The general purposes of our invention are:
To provide protection to physical loss of wireless headsets.
To suspend the wireless headset to its user or carrier.
To make it easy for the user to keep track of their wireless headset.
To provide an accessory for wireless headset users that can be made cheaply and is disposable or expendable when necessary or desired.

### DESCRIPTION

This application claims priority to provisional application No. 61/342,503 filed on Apr. 15, 2010.

The wireless headset holding device in our preferred embodiment is comprised of a small 1-¼″ alligator style clip (FIG. 1, #3) with gripping teeth (FIG. 2, #4) and grips on the arms (FIG. 2, #2). In our preferred embodiment, we use one small ⅜″× 5/16″ zinc coated neodymium magnet (shown in FIG. 2, #3). In our preferred embodiment, the neodymium magnet (FIG. 2, #3 & FIG. 1, #4) is attached to the outside of either arm of the example alligator clip (FIG. 2, #'s) using a metal bonding glue.

The second piece is a small ⅜″ in diameter ferromagnetic material disk (shown in FIG. 5, #1) that is exposed on one side. On the other side, it is coated with an adhesive (FIG. 5, #2) with peel away backing (FIG. 5, #3) which exposes an adhesive (FIG. 5, #2) when removed. In the preferred embodiment and our reduction to practice we used stainless steel with high iron content as the ferromagnetic disk material (FIG. 1, #2). The disk (FIG. 1, #2) is affixed to a wireless headset (FIG. 1, #1) by peeling away the peel away backing (FIG. 5, #3) and pressing the ferromagnetic disk (FIG. 5, #1) with adhesive side (FIG. 5, #2) flush onto the wireless headset (FIG. 1, #1).

The magnet, magnetic, or magnetized material (FIG. 3, #3) and ferromagnetic disk (FIG. 3, #4) would be attracted to each other allowing the wireless headset (FIG. 3, #1) to be easily “docked” or connected by placing the ferromagnetic material (FIG. 4, #5) on or near the magnet (FIG. 4, #4) that is attached to the clip (FIG. 4, #3). This keeps the wireless headset (FIG. 4, #6) readily available, conveniently located and secure as seen in FIG. 4. In FIG. 4 the clip (FIG. 4, #3) is secured on the shirt collar (FIG. 4, #1). The tie (FIG. 4, #2) is for illustrative purposes only.

During periods that wireless headset (FIG. 3, #1) and the invention (FIG. 3, #2) are not being used, the magnet (FIG. 3, #3) and clip (FIG. 3, #2) can be removed from the user and left in the docked position to avoid loss of the magnet and clip apparatus as seen in FIG. 3.

### PRIOR ART

There have been some prior art efforts to create a telephone handset holding device that can specifically be used in conjunction with mobile telephones. For example, U.S. Pat. No. 5,668,869, issued to Zinno, discloses a mobile telephone handset holder that can be used in a motor vehicle. The mobile phone is supported via a device that slides onto a standard car seat belt. While the invention disclosed in Zinno provides adequate support for a mobile telephone, its limitations are clear. The mobile telephone holder disclosed by Zinno can only be used in a car and cannot be utilized by a mobile phone user outside the car. Moreover, the positioning of the mobile phone holder is limited by the position of the seatbelt, thereby severely affecting the possible range of desired positions for the mobile telephone.

U.S. Pat. No. 5,729,615, issued to Yang, discloses an earphone for a mobile telephone handset that fits in the user's ear via a hanger. Yang incorporates a separate speaker element that fits into the user's ear and that must also be connected to the mobile phone via a cord and plug. Although the earphone is easy to transport, it nonetheless requires an additional means of attaching the mobile phone to some other part of the user's body to properly allow the user to utilize the mobile phone without the use of the user's hand. The various components are cumbersome and require multiple installation steps before the user can answer an incoming call or make an outgoing call.

U.S. Pat. No. 6,374,090, issued to Morales, discloses a cellular telephone handset holder that uses a clamp gripping device to support the sides and bottom of a mobile phone, before clipping it to a user's ear. The handset holder comprising multiple pieces and has an inner and outer clip portion that “pinches” the front and back lobes of a user's ear. The Morales' device apparently only works with mobile telephones that are “single piece,” i.e., a phone without any movable components or a phone that doesn't have a “flip open” feature, which is found in many modern mobile telephone handset embodiments. Consequently, the invention disclosed in Morales is limited in use and does not adequately account for the various different types of mobile telephone handset shapes and sizes that permeate today's marketplace.

U.S. Pat. No. 6,639,985, issued to Liu, discloses a phone that utilizes an ear hanger assembly that hangs from a user's ear. While the invention disclosed in Liu addresses some of the problems found in the prior art, it nonetheless requires the permanent installation of the phone hanger to the mobile phone. Consequently, a user is required to physically attach the phone hanger to the mobile phone, adding extra time and cost. Moreover, permanently attaching the phone hanger to the telephone adds unnecessary thickness, girth and weight to the mobile phone, which is disadvantageous given the growing trend of mobile phone manufacturers creating lightweight and slim mobile phones to satiate consumer demand for compactness.

U.S. Pat. No. 7,457,643, issued to Farrell, discloses a unit that utilizes “elongated rods with an adjustable beam cut cradle assembly including a pair of elongate spaced-apart rods wherein a first resilient one of the elongate rods is fixed along a portion of its length so as to be cantilevered. A clamp is supported upon the pair of spaced-apart rods that includes a semi-hollow beam having a central passageway and that is supported a second one of the elongate rods. An adjustable beam is slidingly received within the central passageway of the semi-hollow beam, and is fastened to an end of the first resilient one of the rods so that when the adjustable beam is slid outwardly and away from the semi-hollow beam, the first resilient one of the rods is biased thereby gripping a portion of the communications handset.” Consequently, this would result in rods and sliding beams around the head or attachment area of the user and can be impractical and cumbersome.

The above listed prior art all use different methods and do not list the methods described in this application.

### ADVANTAGES OVER PRIOR ART

Our invention keeps the wireless headset or accessory in closer proximity to the head and ears of the user for easier access and faster application to the ear without the use of obstructive and stiff materials or rods.
Our invention provides a different alternative as to where the wireless headset can be stored.
Our invention removes the need for yet another belt clip or obstructive unit.
Our invention is less obvious and odd looking.
Our invention can be clipped anywhere desired on the user.
Our invention can be made very inexpensively and is ultra-light-weight.
Our invention can hold the wireless headset near the head where it is less likely to be knocked off in comparison to one worn on the hip or belt.

### REFERRING TO OUR DRAWINGS

FIG. 1 is a view of an example headset 1 with ferromagnetic disk applied 2 lying next to the alligator clip 3 with the neodymium magnet attached 4.

FIG. 2 is an enlarged side view of the alligator clip 1 with teeth 4, grips 2, and an attached neodymium magnet 3.

FIG. 3 is the view of one way to store the clip and magnet apparatus while not in use. In FIG. 3, the example wireless headset 1 with a ferromagnetic disk 4 affixed with adhesive to the example headset 1, after the peel away backing has been removed. The clip 2 and the neodymium magnet 3 are one unit and are held to the ferromagnetic disk 4 by magnetic attraction.

FIG. 4 is a drawing of the example wireless headset 6 being suspended from a collar 1. The wireless headset 6 is held by the ferromagnetic disk 5 attached to it which is in turn attracted to the neodymium magnet 4 that is permanently joined with the example alligator clip 3. The tie 2 is included for illustrative purposes only.

FIG. 5 is a drawing of an enlarged, cross-sectioned view of the ferromagnetic disk used in our reduction to practice and preferred embodiment. The layers visible are the ferromagnetic disk 1 stamped out of a metal sheet with adhesive 2 on one side that is temporarily covered by a peel away adhesive backing 3. To apply the disk to a headset, the user removes the peel away backing 3, exposing the adhesive 2 and affixes the ferromagnetic disk to a wireless headset of their choosing by pressing the ferromagnetic disk 1 with adhesive side flush onto the headset or item.

### ALTERNATIVE EMBODIMENTS OF WIRELESS HEADSET PINCHER HOLDING DEVICE

Different materials, sizes and interconnections can be used for some or all components.
In lieu of magnets or line, hooks fasteners, snaps or slot slide joiners can be used.
The units can be disposable/expendable or made from longer lasting, higher quality materials.
Glue, epoxy, molded plastic, knots in the line, groove, snap, button, slot slide, hook or other fasteners can be used to permanently or temporarily join the line or magnet to the clip.
Any type of clip can be used including with or without a spring load.
In place of a magnet and ferromagnetic material relationship, a filament or mono-filament can be used to hold the item.
The clips can be made from any material (with or without rubber grips) in any variety of sizes, shapes or cosmetic appearance.
The metal disk can be made from any ferromagnetic material and in any shape or thickness.
The magnet or ferromagnetic material could be built into the wireless headsets, pacifiers or other items to be docked with it.
The magnet or ferromagnetic material could be built or made into clothing or whatever the item for docking is desired to be attached to.
The magnet or ferromagnetic material can be used interchangeably in the construction of the apparatus.
A small locking mechanism, guided in by the magnetic relationship of the metal and ferromagnetic material can be added to the apparatus in order to make the docked item or wireless headset more secure. This fastener or locking mechanism can them be released by the push or pull of a button or other release. A new mechanism can be developed or one that is common and existing can be used.
A locking mechanism could be used in place of the magnetic docking arrangement.
The pieces can be made into one solid, permanent unit or can be made separately and joined by any method including but not limited to welds, adhesives, peel-away backed adhesives, drops of adhesive, buttons, fasteners, fitted slots or any combination of these or others.
If, in the future, phones are built into headsets so that they are one unit, this apparatus can be used to hold them.
The clip and any other part can be made any size desired.
Two magnets, magnetic materials or magnetized materials could be used instead of one magnetic material and one ferromagnetic material.
The clip can be made entirely or partially by plastic, metal or combination of metals or plastics, rubber, wood, synthetic materials, existing types of clips (for example, Gator Clips).
The ferromagnetic material, magnet, magnetic or magnetized material can be fastened to the wireless headset or clip by glue, a snapping button, a loop, Velcro, swivel, or other method, peel off backing adhesive, drops or glue or adhesive, melted together, be permanently built in during each items manufacture or enclosed by a housing.
The assembled parts can be made to be permanent or semi-permanent.
The glues can be permanent or temporary.
If desired, a small retracting coil of line could also be used to allow the length of line to become longer. The wireless headset would then be attached to the user.
The magnet could be made in any variation of magnetic strength or type.
The magnet, magnetic or magnetized material and or ferromagnetic material could also be covered or dipped in some type of rubber or other material to soften the “click” when touched together or coated with zinc or any anti-corrosive or cosmetic metal or material or purchased that way before assembly or manufacture.
Small welds, glue or other methods of adherent can be used to attach the magnet to the clip and the ferromagnetic material to the headset.
The clip can be made from magnetic material in place of attaching a magnet.

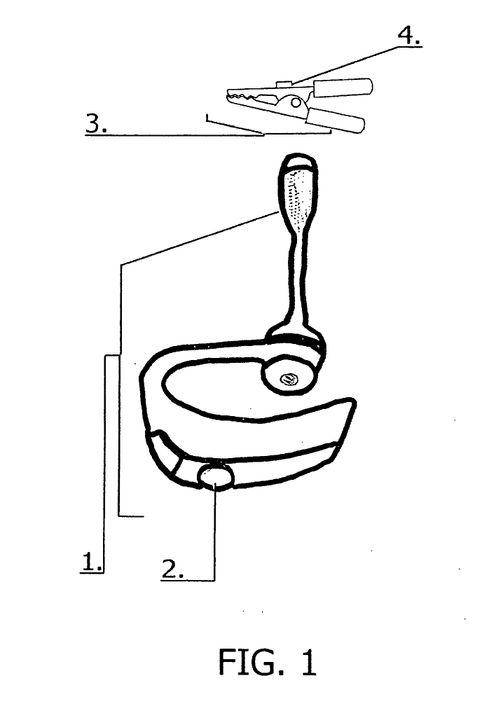

### Table for FIG. 1

1. Example headset
2. ⅜″× 5/16″ ferromagnetic disk attached with adhesive
3. 1″ long clip with magnet attached
4. ⅜″× 5/16″ zinc plated neodymium magnet attached with metal bonding epoxy glue

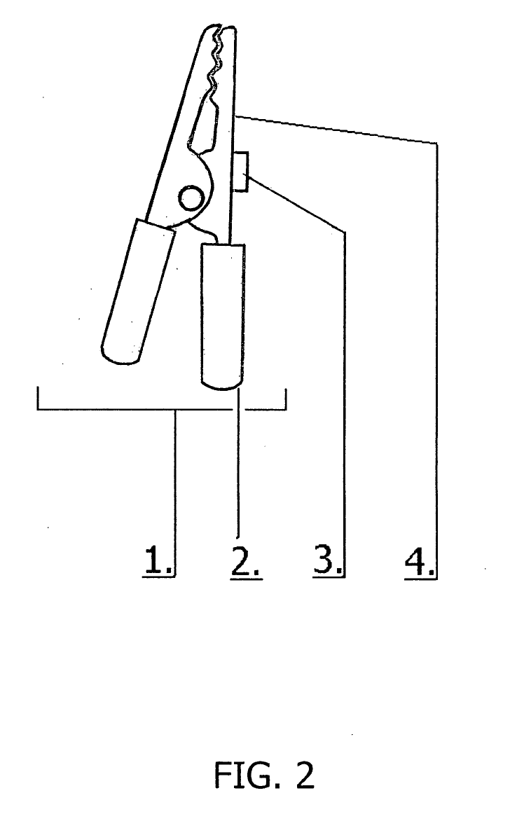

### Table for FIG. 2

1. 1″ alligator clip
2. Rubber grips
3. ⅜″× 5/16″ zinc plated neodymium magnet attached with metal bonding epoxy glue
4. Alligator clip teeth

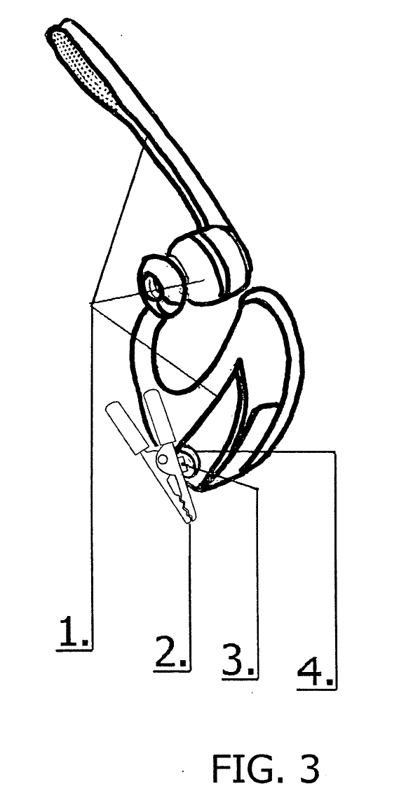

### Table FIG. 3

### 1. Example Headset

2. 1″ alligator clip
3. ⅜″× 5/16″ zinc plated neodymium magnet attached with metal bonding epoxy glue
4. Ferromagnetic disk attached with adhesive

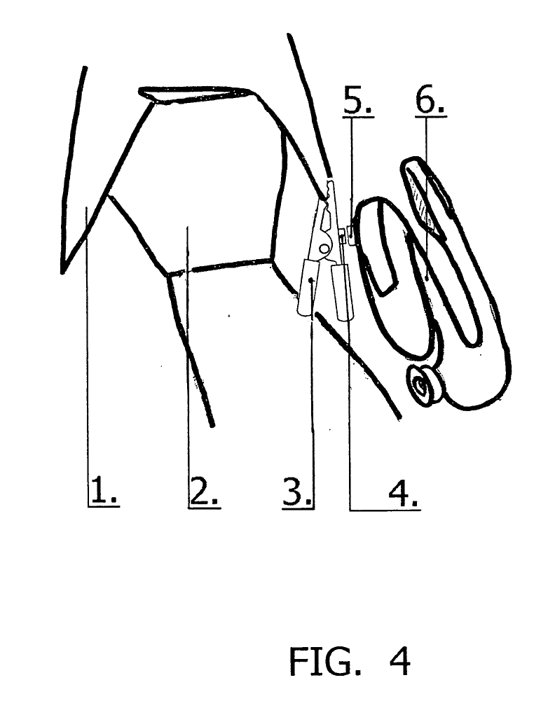

### Table for FIG. 4

### 1. Shirt Collar

2. Men's Tie (for illustrative purposes only)
3. 1″ Example alligator clip with ⅜″× 5/16″ zinc plated neodymium magnet attached with metal bonding epoxy glue
4. ⅜″× 5/16″ zinc plated neodymium magnet
5. ⅜″× 5/16″ ferromagnetic disk attached with adhesive
6. Example wireless headset

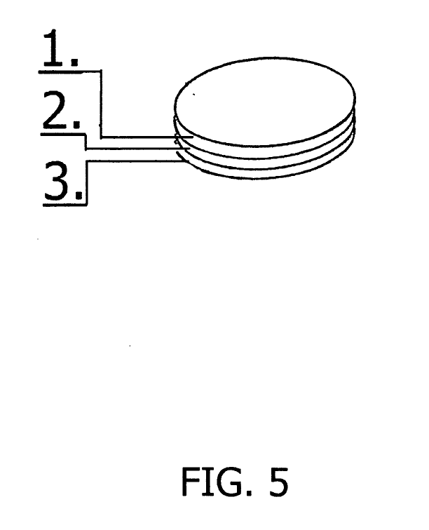

### Table for FIG. 5

1. Ferromagnetic disk

### 2. Adhesive

3. Peel away backing

The embodiments of the invention in which an exclusive property or privilege is claimed are defined as follows:

1) A magnetic clip and magnet, magnetic or magnetized material that will attract a second standard, special, customizable, disk shaped, square or any shape hard or pliable piece made from any ferromagnetic materials or metal exposed on one side with adhesive on the other that is covered by a peel off backing in order to create a temporary docking station for any item.

2) The combination defined in claim 1, wherein the magnet and/or ferromagnetic materials are exchanged or interchangeable.

3) The combination defined in claim 1, wherein the clip, magnet and ferromagnetic materials are exchanged or interchangeable.

4) The combination defined in claim 1, wherein the magnet or ferromagnetic materials are built directly into the clip.

5) The combination defined in claim 1, wherein the magnet or ferromagnetic materials are built into the wireless headset or other item to be held.

6) The combination defined in claim 1, wherein the magnet or ferromagnetic materials are attached by solder or weld.

7) The combination defined in claim 1, wherein the magnet or ferromagnetic materials are built directly into clothing or other items that a wireless headset or item would be attached to.

8) The combination defined in claim 1, wherein the unit is of any type or cosmetic appearance.

9) The combination defined in claim 1, wherein the ferromagnetic material is in a temporary putty-like state and can adapt to any surface.

10) The combination defined in claim 1, wherein the adhesive is thick or has an adaptive material layer in order to adapt for curvature of the wireless device.

11) A magnetic clip and magnet, magnetic or magnetized material that will attract a second hard or pliable piece made from ferromagnetic materials with metal exposed on one side and adhesive on the other that is covered by a peel off backing in order to create a temporary docking station for wireless headsets specifically.

12) The combination defined in claim 11, wherein the magnet, magnetic materials or magnetized materials are reversed.

13) The combination defined in claim 11, wherein the magnet or ferromagnetic materials are built directly into the clip.

14) The combination defined in claim 11, wherein the magnet or ferromagnetic materials are built into the wireless headset or other item to be held.

15) The combination defined in claim 11, wherein the magnet or ferromagnetic materials are attached by solder or weld.

16) The combination defined in claim 11, wherein the magnet or ferromagnetic materials are built directly into clothing or the wireless headsets themselves.

17) The combination defined in claim 11, wherein the ferromagnetic material is in a temporary putty-like state and can adapt to any surface.

18) A magnetic clip and magnet, magnetic or magnetized material that will attract a second customizable, disk shaped, square or any shape hard or pliable piece made from ferromagnetic materials or metal that is exposed on one side with adhesive on the other that is covered by a peel off backing in order to create a temporary docking station for holding pacifiers.

19) The combination defined in claim 18, wherein the ferromagnetic material is in a temporary putty-like state and can adapt to any surface.

20) The rights to the heretofore mentioned claims and their alternative embodiments.
